(19) United States
(12) Patent Application Publication
(10) Pub. No.: US 2004/0224061 A1
(43) Pub. Date: Nov. 11, 2004

(54) Frozen fillet or slice of fish meat, or a frozen processed fillet or slice of fish meat, in which degeneration due to TMAO is inhibited or prevented during freeze-storage

(76) Inventors: Takashi Mori, Tokyo (JP); Yoshie Oishi, Tokyo (JP); Toru Mizuguchi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/771,505

(22) Filed: Feb. 5, 2004

(30) Foreign Application Priority Data
Feb. 7, 2003 (JP) 2003/30604

(51) Int. Cl. C12H 1/10

(52) U.S. Cl. 426/321

(57) ABSTRACT

Provided is a frozen fish fillet or slice, or a frozen processed fillet or slice of fish meat preferably prepared from white-meat fish in which degeneration due to the decomposition of trimethylamine-N-oxide (TMAO) which would otherwise occur during freeze-storage is inhibited, which is brought about by subjecting the fillet or slice to water immersion treatment and/or oxidation treatment prior to freeze-storage. Specifically, inhibition of the decomposition of TMAO in fish fillet or slice during freeze-storage is achieved by transferring the fillet or slice to an oxygen-packed container, subjecting the meat preparation to oxygen substitution treatment, or exposing the meat preparation to an oxidant-containing solution, prior to freeze-storage.

### BACKGROUND OF THE INVENTION

1. Field of the Invention

The present invention relates to a frozen fillet or slice of fish meat in which degeneration due to the decomposition of trimethylamine-N-oxide (TMAO hereinafter) is inhibited and prevented while fish meat is frozen-stored, and to a frozen processed fillet or slice prepared from such fish meat.

The expression “degeneration of fish meat during freeze-storage” used herein refers to the degeneration of fish meat which would occur unless properly treated while the meat is frozen-stored, which causes the meat to emit a foul odor and to harden, and the insolubility of proteins in the meat to salt to increase. The susceptibility of fish meat to degeneration during freeze-storage varies depending on the species of fish from which the meat is prepared, and the storage conditions should be adjusted according to the susceptibility. For example, if meat prepared from pollock is frozen-stored at −10° C. for four weeks, the meat becomes brittle or has a gum-like texture, and the solubility of proteins to salt becomes 10% or lower.

The term “fillet” used herein refers to a meat plate obtained by removing, from a fish body, its head and viscera, and slicing the remaining meat block into two or three plates, and includes any fish meat plate obtained as above regardless of whether the plate has skin or bone attached thereto. The term “slice” used herein refers to a meat slice obtained by slicing a meat plate into thin pieces, and includes any meat slice obtained as above regardless of its size and shape. The term “a frozen processed fillet or slice of fish meat” used herein refers to a frozen fish meat product obtained by shaping fillets or slices prepared as above, seasoning them, and coating them, that is, processing the fillets or slices, and freeze-storing them, and is not limited by the order of the procedures: the processing may be introduced subsequent or prior to the freeze-storage.

2. Description of the Related Art

Fillets of meat of white-meat fish are evaluated according to their texture, juiciness, and odor. TMAO is present at 50-100 mmol/kg in the meat of fish belonging to the Gadus family, and turns into dimethyl amine (DMA) and formaldehyde (FA) as a result of decomposition. FA acts as an agent to denaturate the proteins in the meat, and it is suspected that FA is involved in the lowered gelling activity of frozen fish meat, which causes the meat to have a hard texture.

Generally, when meat is prepared from the fish species whose meat contains a rich amount of TMAO such as pollock, southern cod and blue grenadier(Hoki), it is minced then washed with cold water, and the minced meat is frozen-stored to be processed later into food materials. This technique, surimi technique has been intensively used for producing fish meat-based food materials having wide applicability.

However, if fillets or slices prepared from meat of the above fish species must be frozen-stored, it is necessary to suppress the reaction involving TMAO as much as possible during the freeze-storage. No such technique, however, has been offered to date. Therefore, even if processed fish meat is frozen rapidly, the reaction in question proceeds in the meat during freeze-storage, which causes the meat to harden and to emit a foul odor, and the insolubility of proteins to salt to develop rapidly. Therefore, food materials prepared from such fish meat will lose their marketing value. The main cause of those events is FA produced as a result of the decomposition of TMAO in the meat, which facilitates cross-linking reactions between adjacent protein molecules, and thereby causes the meat to harden and the insolubility of protein in the meat to salt to be enhanced. DMA, which is produced at the same molar concentration to that of FA during the decomposition of TMAO, is responsible for the foul odor.

Here, the process underlying the development of FA and DMA in association with the decomposition of TMAO will be briefly outlined. As has been frequently observed in fish of the Gadus family, TMAO in the muscle reacts with iron and water in the tissues under a reducing environment to produce Schiff bases, which are then converted into FA and DMA as seen in Formula 1 (C. Castell, B. Smith and W. Neal, J. Fish Res. Bd. Can., 28:1-5 (1971)):

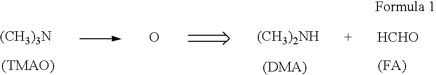

This process occurs as a simple chemical reaction. In addition, there are enzymes in the fish muscle which are capable of digesting TMAO. Therefore, intramuscular decomposition of TMAO occurs whether the muscle is kept at a temperature higher than 0° C. or lower than 0° C. The decomposition of TMAO observed in frozen-stored fish meat occurs largely non-enzymatically. In any case, once FA is formed, because of its high reactivity, it facilitates the cross-linking of amino acids, peptides and proteins, and thus the solubility of proteins to salt rapidly lowers. Namely, the proteins in the fish meat are denaturated. DMA generates a disagreeable odor characteristic in tainted fish meat, which significantly lowers the marketing value of the resulting food material.

It has been reported that the reaction leading to the decomposition of TMAO requires a reducing environment and iron (K. L. Parkin and H. O. Hultin, J. Biochem., 100:77-86 (1986)).

Reece found that, when minced cod(Gadus morhua) muscle is frozen-stored, the decomposition of TMAO is reduced on the surface of the meat. He suggests based on the finding that oxygen may inhibit the activity of enzymes responsible for the decomposition of TMAO (J. Sci. Food Agric., 34:1108-1112 (1983)). G. Boer, and O. Fennema observed a similar phenomenon: degeneration of frozen fish meat during freeze-storage is inhibited, when the meat is stirred. They assumed that oxygen may partially interfere with the activity of enzymes responsible for the digestion of TMAO (J. Food Sci., 54(6):1524-1529 (1989)). All the authors of the above studies presumed that the decomposition of TMAO occurs as a result of digestion due to enzymes, and interpreted the above phenomena by assuming that oxygen inhibits the activity of those enzymes.

In spite of the above knowledge that oxygen could inhibit the degeneration of frozen fish meat, no attempt has been made to study the mechanism underlying the oxygen-induced inhibition of FA formation, much less its practical application. This is because the minced meat and fillets of fish meat contain a large amount of lipids and thus, if they are frozen-stored without due care under normal atmosphere, the lipids will be oxidized in the presence of oxygen contained in the atmosphere, that is, undergo so-called fat burn, and the oxidized lipids will then modify proteins in the meat, which leads to the degradation of the meat (K. Kawasaki and T. Oizumi, Foods & Food Ingredients J. Jpn., 175:92-98, (1998)).

To maintain the color of the meat of red-meat fish, a method was introduced which consists of exposing the fish meat to oxygen or ozone, thereby oxidizing myoglobin and hemoglobin in the meat (Japanese Unexamined Patent Application Publication No. 2002-34444).

### SUMMARY OF THE INVENTION

Accordingly, it is an object of the present invention to provide a frozen fish fillet or slice or a frozen processed fillet or slice of fish meat in which degeneration due to the decomposition of TMAO is inhibited and prevented while fish meat is frozen-stored. Particularly, the object of the present invention is to provide an improved preservation of white fish preparations such as fillets or slices of meat, which does not require any special additive for the purpose.

An object of the present invention is to provide a frozen fillet or slice of fish meat, or a frozen processed fillet or slice of fish meat, in which degeneration due to the decomposition of TMAO which would otherwise occur when fish meat is frozen-stored is inhibited by subjecting the fillets or slices to water-immersion treatment and/or oxidation treatment.

Specifically, an object of the present invention is to provide a frozen fillet or slice of fish meat, or a frozen processed fillet or slice of fish meat, prepared preferably from the meat of white-meat fish in which degeneration due to the decomposition of TMAO which would otherwise occur when fish meat is frozen-stored is inhibited by subjecting the fillets or slices to oxygen pack treatment.

Another object of the present invention is to provide a frozen fillet or slice of fish meat, or a frozen processed fillet or slice of fish meat, prepared preferably from the meat of white-meat fish in which degeneration due to the decomposition of TMAO which would otherwise occur when fish meat is frozen-stored is inhibited by subjecting the fillets or slices to oxygen substitution treatment.

Alternatively, an object of the present invention is to provide a frozen fillet or slice of fish meat, or a frozen processed fillet or slice of fish meat, prepared preferably from the meat of white-meat fish in which degeneration due to the decomposition of TMAO which would otherwise occur when fish meat is frozen-stored is inhibited by exposing the fillets or slices to an oxidant.

The object of the present invention is to provide a frozen fillet or slice of fish meat, or a frozen processed fillet or slice of fish meat, prepared preferably from the meat of white-meat fish in which degeneration of the meat due to the decomposition of TMAO which would otherwise occur when fish meat is frozen-stored is inhibited, the inhibition of TMAO decomposition occurring as a result of the oxidation or oxygenation of iron, iron-containing substances and/or reducing agents in the meat which is brought about by water immersion treatment and/or oxidation treatment applied to the fish meat.

According to the method of the present invention, it is possible to inhibit, during freeze-storage, the decomposition of TMAO which will otherwise occur during freeze-storage, of fillets prepared from fish species whose meat contains TMAO, and to prevent the degeneration of the processed meat which otherwise might be brought about as a result of such decomposition, thus preventing the degradation of food products prepared from the processed meat. When fillets prepared from fresh fish or obtained by thawing frozen fish must be frozen-stored, the treatment of the present invention should be applied to the fillets before freeze-storage. Then, it is possible to inhibit the decomposition of TMAO which would otherwise occur in the meat during freeze-storage, and thus to preserve the fillets over a longer period without damaging their flavor and nutritious value. The treatment effect is invariable regardless of the shape of the fillets, or whether the fillets are coated or not. The treatment is also applicable to frozen food products incorporating fish meat.

### BRIEF DESCRIPTION OF THE DRAWINGS

FIG. 1 represents the decomposition of TMAO over time in fish fillet samples while the samples are frozen-stored (this test was performed on three samples (n=3) prepared from three different individuals A, B and C).

FIG. 2 represents, when fish fillet samples are frozen-stored, the change over time of the solubility of proteins in the meat to salt (this test was performed on three samples (n=3) prepared from three different individuals A, B and C).

FIG. 3 represents the decomposition of TMAO in fish fillet samples over time during freeze-storage, when the samples were previously exposed to an aqueous solution of hydrogen peroxide.

FIG. 4 represents the decomposition of TMAO in fish fillet samples over time during freeze-storage, when the samples were previously immersed in water for five minutes with or without stirring.

FIG. 5 represents the content of TMAO of fish fillet samples immediately after they were immersed in water, as well as that of untreated samples.

FIG. 6 represents the decomposition of TMAO over time in fish fillet samples during freeze-storage, when the samples are frozen-stored in oxygen packs.

FIG. 7 represents, when fish fillet samples are frozen-stored in oxygen packs, the change over time of the solubility of proteins in the samples to salt during freeze-storage.

FIG. 8 represents, when fish fillet samples are frozen-stored in oxygen packs with the concentration of oxygen being varied, the decomposition of TMAO over time in the fish fillet samples during the freeze-storage.

FIG. 9 represents the decomposition of TMAO over time in fish fillet samples during freeze-storage, when the samples were previously subjected to oxygen substitution treatment.

FIG. 10 represents the decomposition of TMAO over time in fish fillet samples during freeze-storage when the samples were previously exposed to different substitution gases.

### DESCRIPTION OF THE PREFERRED EMBODIMENTS

The present invention provides a method for producing processed fish meat in which the absolute content of TMAO is reduced and/or decomposition of TMAO is inhibited by subjecting the meat to water-immersion and/or oxidation treatment, and thus the denaturation of proteins due to FA and the generation of a foul odor due to DMA are minimized.

The freeze-storage of the present invention can be used for storing fish meat prepared not only from industrially important fish such as pollock, southern cod, blue grenadier, bream, croaker, etc., which are caught in large amounts annually, but also meat of any common fish and shellfish whose meat is served for meals and contains TMAO. The content of TMAO in the meat varies depending on the fish species from which the meat is prepared. If the content of TMAO in the meat of pollock is taken as 100, that of croaker meat will be 20. On the other hand, the TMAO content of the surimi, minced and water-immersed meat, of pollock will be about 5. The preserving effect of the freezing method of the present invention significantly varies depending on the TMAO content of the meat to which the method is applied. However, the method of the present invention is effective with any fish meat, as long as the meat contains TMAO.

It is possible according to the freezing method of the invention to inhibit the decomposition of TMAO of fish meat during freeze-storage by oxidizing the meat prior to the freeze-storage, the oxidation being achieved by wrapping the meat with a pack containing an oxygen-containing gas, subjecting the meat to oxygen substitution treatment, or exposing the meat to an oxidizing agent. Oxidation of the meat may be achieved by exposing the meat to light. These treatments are preferably applied to raw meat prepared from freshly caught fish, but may also be effective with meat obtained by thawing frozen-stored meat.

Illustrative examples of iron-containing substances in the muscle are hemoglobin and myoglobin. The physiological function of hemoglobin and myoglobin is the transference of molecular oxygen and its storage. The binding of molecular oxygen to hemoglobin and myoglobin is called oxidation or oxygenation.

Iron in the muscle exists not only as heme molecules as in hemoglobin and myoglobin, but also as non-heme molecules. With regard to iron contained in non-heme molecules, when iron existing as a ferrous compound (Fe²⁺) is converted to a ferric compound (Fe³⁺), the conversion is also called oxidation.

The oxidizing agent or oxidant used for the oxidation treatment includes, to mention a few as non-limiting examples, hydrogen peroxide or ozone which is dissolved in water. When hydrogen peroxide is used, its concentration is 1000 ppm or higher, preferably 5000 ppm or higher. When ozone is used, its concentration is 0.5-5 ppm, preferably 0.5-2 ppm. The weight of an oxidation solution with respect to that of the fish meat to be treated is 1-100 fold, preferably 5-20 fold. The immersion time is 1-60 minutes, preferably 1-10 minutes.

The oxygen-containing gas to be used for the oxygen substitution treatment contains oxygen at 50 mmHg or higher, preferably 160 mmHg or higher. Reduced pressure to be maintained for oxygen substitution is set to 760 mmHg or lower, preferably 400 mmHg or lower. Pressure reduction cycle occurs 1-50 times, preferably 10-20 times.

The oxygen-containing gas transferred in an oxygen pack contains oxygen at 50 mmHg or higher, preferably 160 mmHg or higher. The volume of oxygen-containing gas with respect to that of the fish meat to be treated is 1-10 fold, preferably 1-3 fold.

The light source used for photo-oxidation includes, to mention as non-limiting illustrative examples, a fluorescent lamp, ultra-violet light, an incandescent lamp, pulsed light, infra-red light, etc. The radiation time of light is 10-60 minutes, preferably 30-60 minutes.

The water immersion treatment consists of immersing fish meat in water or an aqueous solution of a salt. The amount of salt added with respect to the weight of water is 0.01-5%, preferably 0.5-2%. The immersion time is 1-60 minutes, preferably 1-5 minutes. The weight of the treatment solution with respect to that of the fish meat to be treated is 1-50 fold, preferably 3-30 fold. While the fish meat is immersed in the solution, the solution is preferably stirred.

### EXAMPLES

The details of the present invention will be described by means of examples. However, the invention specified in this application is not limited in any way by those examples.

Assay of DMA was achieved by the copper-dithiocarbamate method developed by Dyer and Mounsey.

### Example 1

[Method]

Fillets of 500 g (oxygen-treatment sample) prepared from pollock were placed in a vacuum desiccator. The air was aspirated from the desiccator until its pressure was lowered to 100 mmHg, and then pure oxygen was introduced until the initial atmospheric pressure was recovered (one treatment-gas entry cycle). Another sample of fillets (nitrogen-treatment sample) was similarly treated, except for the usage of pure nitrogen instead of pure oxygen. The treatment-gas entry cycle was repeated 10 times for each sample. Each fillet sample was frozen immediately after the gas treatment, and stored at −10° C. for four weeks. For each sample, its DMA content was determined after the freeze-storage.

[Result]

The results are shown in Table 1.

TABLE 1

| | | After freeze- |
|---|---|---|
| | Immediately after | storage at −10° C. |
| | treatment | for 4 wks |
| Nitrogen gas | 1.19 | 4.11 |
| treatment | | |
| Oxygen gas | 1.19 | 2.83 |
| treatment | | |

It is obvious from the results that the oxygen treatment of fish fillets inhibits the decomposition of TMAO in the meat.

### Example 2

[Method]

Fillets of 500 g (hydrogen peroxide-treatment sample) prepared from pollock were immersed in a 0.1% aqueous solution of hydrogen peroxide having the same weight as that of the fillets and then placed in a vacuum desiccator. The air was aspirated from the desiccator until its pressure was lowered to 100 mmHg, and then air was introduced until the initial atmospheric pressure was recovered. This air pressure changing cycle was repeated five times. The fillet sample was frozen immediately after the hydrogen peroxide treatment, and stored at −10° C. for two weeks. The DMA content of the sample was determined after the freeze-storage. Another sample of fillets (control sample) was similarly treated, except for the usage of physiological saline instead of the aqueous solution of hydrogen peroxide.

[Result]

The results are shown in Table 2

TABLE 2

| | | After freeze- |
|---|---|---|
| | Immediately after | storage at −10° C. |
| | treatment | for 2 wks |
| Physiol. saline | 1.19 | 2.44 |
| treatment | | |
| Hydrogen peroxide | 1.19 | 1.46 |
| treatment | | |

It is obvious from the results that the oxidation treatment of fish fillets inhibits the decomposition of TMAO in the fillets.

### Comparative Example 1

Severity test applied to untreated fillets of pollock

[Method]

A frozen fillet block prepared from pollock was sliced (in parallel with the muscle fibers) into plates having a size of 10×5×1 cm. The plates were thawed, packed in a wrap, rapidly frozen at −40° C. for 12 hours, and stored under a severe condition (frozen at −10° C. for four to six weeks). The DMA content of the fillet sample was determined after the freeze-storage.

Assay of the DMA content of the plates and the solubility of proteins thereof to salt was undertaken as follows. The frozen sample was removed of the dark-flesh, and sufficiently homogenized with a food cutter. Chemical analysis was achieved by taking six pieces of fillets, combining them using the above method, and subjecting them to measurement.

The solubility of proteins to salt was assessed by determining the solubility of actomyocin or a protein that accounts for 50% or more of the total proteins contained in the fish meat, to a salt solution (0.5 M NaCl-20 mM Tris-HCl (pH 7.5) buffer).

[Result]

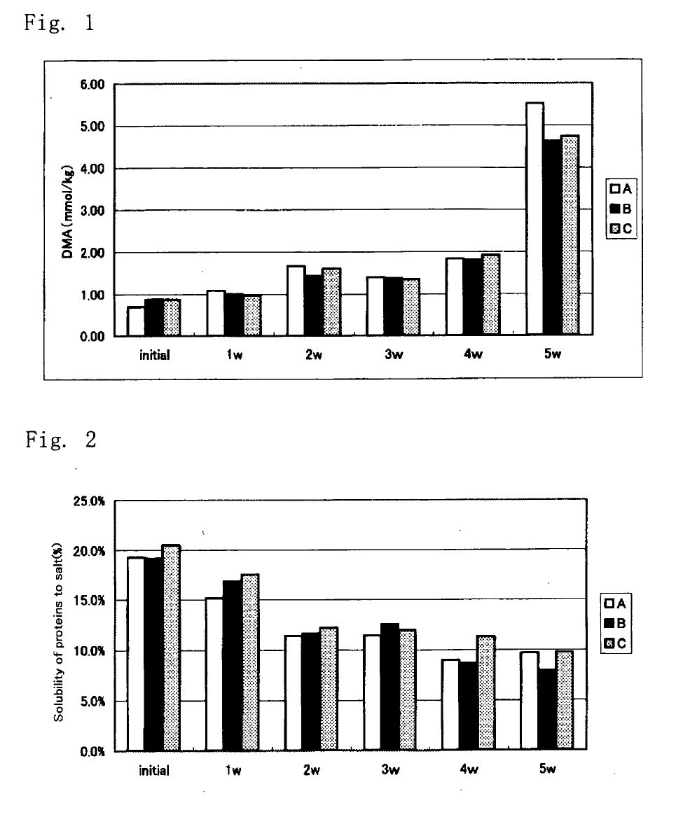

FIG. 1 shows the decomposition over time of TMAO in a fillet sample of pollock while the sample was frozen-stored under a severe condition (frozen at −10° C. for five weeks), and FIG. 2 shows, for the same fillet sample, the solubility of proteins of the sample to salt during the freeze-storage. The change over time of the solubility of proteins of the fish meat to salt reflects the temporal structural change of proteins in the meat. In the pollock fillet sample, decomposition of TMAO proceeds rather slowly up to the fourth week of freeze-storage (decomposition proceeds up to 1.5 mmol/kg in terms of DMA content). Decomposition of TMAO increases rapidly at the fifth week of freeze-storage. In parallel with the increased decomposition of TMAO with time, the solubility of proteins to salt decreases with time until it is below 10% at the third to fifth week of freeze-storage, suggesting the occurrence of protein denaturation at those periods.

### Example 3

The effect of oxidation due to an oxidizing agent

[Method]

The effect of oxidation due to hydrogen peroxide was studied using the same method as in Comparative Example 1. The oxidation treatment consisted of immersing a fillet sample for one minute in a 0.5% aqueous solution of hydrogen peroxide which has a weight five times that of the fillet sample.

[Result]

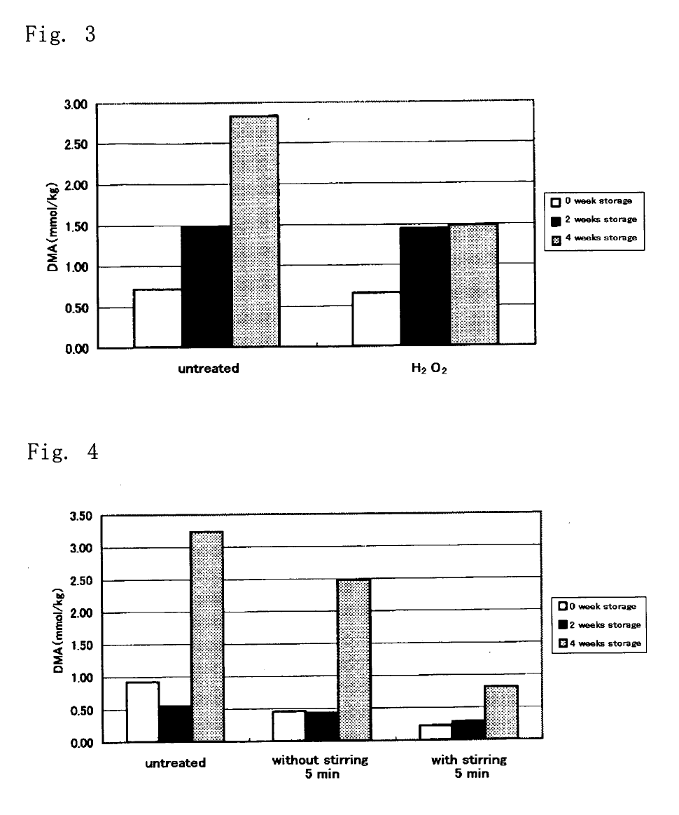

FIG. 3 shows the DMA content over time of the fillet sample during freeze-storage when the sample received hydrogen peroxide-based oxidation treatment prior to the freeze-storage. As a result it was found that the decomposition of TMAO during freeze-storage is retarded more significantly in the fillet sample treated with hydrogen peroxide than in the untreated sample and the sample treated with pure water.

### Example 4

Water immersion treatment

[Method]

The effect of water immersion treatment was studied using the same method as in Comparative Example 1.

The water immersion treatment consisted of immersing a fillet sample in water for one or five minutes with or without stirring. The water was physiological saline (0.9% NaCl), and had a weight two times that of the fillet sample.

[Result]

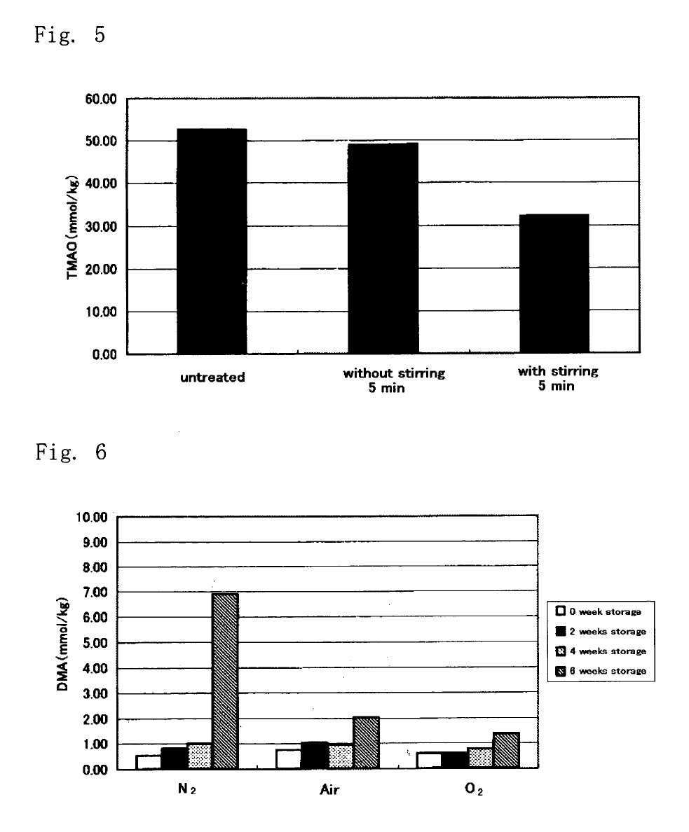

FIG. 4 shows the decomposition over time of TMAO in the fillet sample during its freeze-storage under a severe condition, the fillet receiving the water immersion treatment prior to the freeze-storage. FIG. 5 shows the TMAO content of the fillet sample immediately after the water immersion treatment.

As a result of the test it was found that, in the sample which was immersed in water for one or five minutes prior to freeze-storage, the decomposition of TMAO is more effectively inhibited up to the fourth week of severe freeze-storage than in the untreated sample. The TMAO content of the sample at the termination of four-week freeze-storage was the highest in the untreated sample, which was followed by the non-stirred sample and then by the stirred sample. The TMAO content of the sample at the termination of four-week freeze-storage is the lowest in the sample which was immersed, prior to freeze-storage, in water with stirring for a longer period.

It remains unclear whether the inhibitory effect of water immersion treatment on the decomposition of TMAO in the sample should be ascribed to the penetration of oxygen molecules in water into the fillet sample, or the efflux (or dilution) of certain water-soluble agents responsible for the decomposition of TMAO from the sample into water.

### Example 5

Effect of oxidation treatment

[Method]

The effect of oxidation treatment on the decomposition of TMAO was studied by a method similar to that used in Comparative Example 1.

(1) Oxygen pack

A fillet sample placed in an aluminum pouch filled with oxygen was frozen-stored. The pressure of oxygen in the pouch was adjusted to 0, 80, 160, 320, or 760 mmHg. The aluminum pouch had a volume of about 1000 ml, and the fillet sample consisted of three fillets each weighing 60-70 g. The sample was left in the pouch without being covered with a wrap.

(2) Oxygen substitution treatment

A fillet sample was subjected to oxygen substitution treatment. The treatment consisted of placing the fillet sample in a desiccator kept at 10° C., aspirating the air from the desiccator until its pressure was lowered to 300 mmHg, and introducing pure oxygen into the dessicator until the atmospheric pressure (normal atmospheric pressure, i.e., 760 mmHg) was recovered (oxygen entry cycle). The oxygen entry cycle was repeated 0, 5, 10 or 20 times. The contents of ferric and ferrous compounds in the sample to which the oxygen entry cycle had been repeated 20 times were determined by ESR (electron spin resonance), and the ratio of the former against the latter was calculated. As a comparison, a fillet sample was similarly treated except for the usage of air instead of pure oxygen. The treatment gas entry cycle was set to 20 times.

[Result]

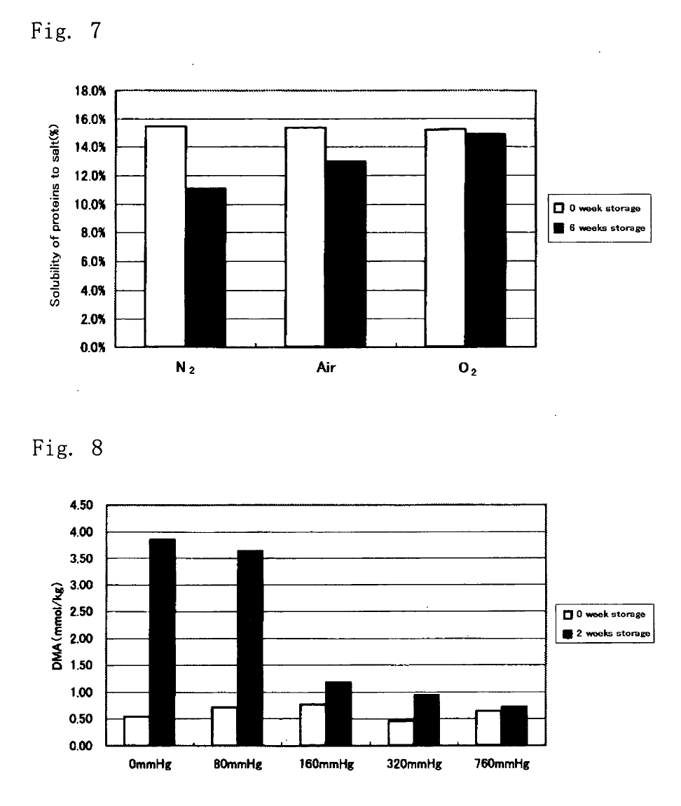

FIG. 6 shows the decomposition of TMAO of the fillet sample during severe freeze-storage which received the oxygen pack treatment, and FIG. 7 compares the solubility of proteins in the sample to acid before and after six-week freeze-storage. As a result of the test, it was found that TMAO is more vigorously decomposed as the treatment gas is shifted in the order of oxygen, air and nitrogen, that is, the oxygen treatment inhibits the decomposition of TMAO in the sample the most effectively. The solubility of proteins to acid during freeze-storage maintains a higher level in the sample receiving the oxygen treatment as compared with the samples receiving the nitrogen or air treatment.

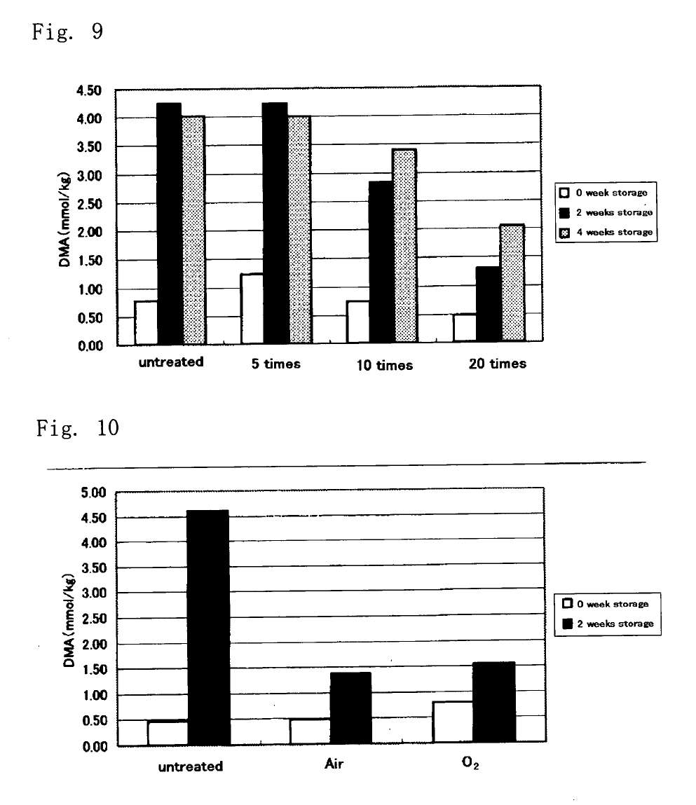

In the above test, the treatment with air was found to be effective in inhibiting the decomposition of TMAO. To further check the effect of oxygen, the concentration of oxygen was varied to 0, 80, 160, 320 and 760 mmHg in terms of its partial pressure, and its inhibitory effect on the TMAO decomposition during freeze-storage was assessed as above (FIG. 8). When compared in terms of the decomposition of TMAO at the second week of freeze-storage, the samples treated with oxygen having a partial pressure of 160 mmHg or higher showed a significantly retarded decomposition of TMAO as compared with the samples treated with oxygen having a partial pressure of 80 mmHg or lower. This shows that exposure of fish fillets to an atmosphere in which the oxygen partial pressure is 160 mmHg or higher prior to freeze-storage will somewhat retard the decomposition of TMAO of the meat during freeze-storage. FIG. 9 shows the decomposition, during severe freeze-storage, of TMAO of the fillet samples which previously received oxygen substitution treatment in which the number of oxygen entry cycles was varied. In each sample, the content of DMA was the highest at the termination of the severe freeze-storage lasting four weeks. The DMA level at the termination of four-week freeze-storage tended to become lower as the oxygen entry cycle was more frequently repeated: the DMA level (about 2.0 mmol/kg) of the sample that received 20 cycles of oxygen refreshment was significantly lower than the DMA levels (3.5-4.0 mmol/kg) of other samples that had received fewer cycles of oxygen refreshment.

With regard to the solubility of proteins to salt during freeze-storage, it stays at a higher level as the number of oxygen refreshment cycles the sample receives becomes higher, during second-week frozen-storage.

As a comparison, a fillet sample was similarly treated except for the usage of air instead of pure oxygen. The treatment gas entry cycle was repeated 20 times. The results are shown in FIG. 10. This shows that the air treatment is as effective as the pure oxygen treatment in inhibiting the decomposition of TMAO during freeze-storage.

It is possible according to the method of the present invention to provide fish fillets or slices which can be preserved by freezing without damaging their marketing value over a longer period without special additives than is possible with conventionally frozen-stored-fish fillets.

1. A frozen fillet or slice of fish meat, or a frozen processed fillet or slice of fish meat, in which degeneration due to the decomposition of trimethylamine-N-oxide which would otherwise occur during freeze-storage is inhibited, which is brought about by subjecting the fish meat to water immersion treatment and/or oxidation treatment prior to freeze-storage.

2. A frozen fillet or slice of fish meat, or a frozen processed fillet or slice of fish meat as described in claim 1 wherein the oxidation treatment comprises transferring the fillet or slice to an oxygen-packed container.

3. A frozen fillet or slice of fish meat, or a frozen processed fillet or slice of fish meat as described in claim 1 wherein the oxidation treatment comprises subjecting the fillet or slice to oxygen substitution treatment.

4. A frozen fillet or slice of fish meat, or a frozen processed fillet or slice of fish meat as described in claim 1 wherein the oxidation treatment comprises immersing the fillet or slice in an oxidant-containing solution.

5. A frozen fillet or slice of fish meat, or a frozen processed fillet or slice of fish meat as described in any one of claims 1 to 4 in which iron, iron-containing substances, and/or, reducing agents in tissues are oxidized or oxygenated.

6. A frozen fillet or slice of fish meat, or a frozen processed fillet or slice of fish meat as described in any one of claims 1 to 4 which are prepared from white-meat fish.

7. A method of producing a frozen fillet or slice of fish meat, or a frozen processed fillet or slice of fish meat, in which degeneration due to the decomposition of trimethylamine-N-oxide which would otherwise occur during freeze-storage is inhibited, said method comprising:
subjecting the fish meat to water immersion treatment and/or oxidation treatment prior to freeze-storage.

8. A method of producing a frozen fillet or slice of fish meat, or a frozen processed fillet or slice of fish meat as described in claim 7, wherein said oxidation treatment comprises transferring the fillet or slice to an oxygen-packed container.

9. A method of producing a frozen fillet or slice of fish meat, or a frozen processed fillet or slice of fish meat as described in claim 7, wherein said oxidation treatment comprises subjecting the fillet or slice to oxygen substitution treatment.

10. A method of producing a frozen fillet or slice of fish meat, or a frozen processed fillet or slice of fish meat as described in claim 7, wherein said oxidation treatment comprises immersing the fillet or slice in an oxidant-containing solution.

11. A method of producing a frozen fillet or slice of fish meat, or a frozen processed fillet or slice of fish meat as described in any one of claims 7 to 10, in which iron, iron-containing substances, and/or, reducing agents in tissues are oxidized or oxygenated.

12. A method of producing a frozen fillet or slice of fish meat, or a frozen processed fillet or slice of fish meat as described in any one of claims 7 to 10, wherein fish meat is prepared from white-meat fish.
